(19) United States
(12) Patent Application Publication
(10) Pub. No.: US 2010/0142481 A1
(43) Pub. Date: Jun. 10, 2010

(54) APPARATUS AND METHOD FOR TRANSMITTING AND RECEIVING SIGNAL FOR HANDOFF IN BROADCASTING NETWORK

(75) Inventors: Hyoungsoo LIM, Daejeon (KR); Heung-Mook KIM, Daejeon (KR); Soo-In LEE, Daejeon (KR)

Correspondence Address: LADAS & PARRY LLP, 224 SOUTH MICHIGAN AVENUE, SUITE 1600, CHICAGO, IL, 60604, US

(73) Assignee: ELECTRONICS AND TELECOMMUNICATIONS RESEARCH INSTITUTE, Daejon (KR)

(21) Appl. No.: 12/632,312

(22) Filed: Dec. 7, 2009

(30) Foreign Application Priority Data
Dec. 8, 2008 (KR) 10-2008-0124313
Nov. 30, 2009 (KR) 10-2009-0117389

(51) Int. Cl. H04W 36/00

(52) U.S. Cl. 370/331; 370/332

(57) ABSTRACT

An apparatus for transmitting a signal for handoff in a transmitter of a broadcasting network where a plurality of center frequencies exist includes: a baseband broadcasting signal generation unit configured to generate a baseband broadcasting signal from broadcasting data to be transmitted; a transmitter identification signal sequence generation unit configured to generate a transmitter identification signal of the transmitter; a first transmission unit configured to combine the baseband broadcasting signal and the transmitter identification signal, and up-convert the combined signal to a center frequency of the transmitter; and a second transmission unit configured to modulate the transmitter identification signal, and up-convert the modulated transmitter identification signal to center frequencies of adjacent transmitters.

### CROSS-REFERENCE(S) TO RELATED APPLICATIONS

The present application claims priority of Korean Patent Application Nos. 10-2008-0124313 and 10-2009-0117389, filed on Dec. 8, 2008, and Nov. 30, 2009, respectively, which are incorporated herein by reference in their entirety.

### BACKGROUND OF THE INVENTION

1. Field of the Invention

Exemplary embodiments of the present invention relates to an apparatus and method for transmitting and receiving a signal in a broadcasting network; and, more particularly, to an apparatus and method for transmitting and receiving a signal for handoff in a broadcasting network.

2. Description of Related Art

Various types of broadcasting services are currently available. Such various broadcasting services tend to provide high-quality broadcasting services and a variety of audio-visual information, while providing digital broadcasting services rather than the existing analog broadcasting services. The existing analog scheme and the digital scheme will be descried below.

The existing analog scheme uses a Multi Frequency Network (MFN), which provides the broadcasting service by changing the channel with the use of a frequency different from a center frequency, in order to prevent the crosstalk of the same frequency in the shadow zone of the broadcasting station or auxiliary station. If the frequency resource is not limited, the MFN is an ideal operation scheme which has no internchannel interference because the broadcasting is provided while allocating different frequencies. However, the available frequency resource is limited, and the use of the MNF scheme is disadvantageous in view of the frequency use as various services are developed and introduced. To solve those problems, much attention has been paid to a Single Frequency Network (SFN) which efficiently uses the finite frequency resource. The SFN may not be used in the analog scheme due to interference caused by the use of the same frequency. However, due to the development of the digital technology, the SFN can be used in the digital broadcasting system.

In the SFN environment, performance degradation may be caused by interference of signals transmitted from adjacent transmitters. To solve this problem, regarding receivers located at the area where two or more signals of the adjacent transmitters are received, the transmission timing of the adjacent transmitters must be adjusted so that the reception timing difference of the signals transmitted from the adjacent transmitters is less than a channel equalization range of a general receiver. To this end, an analysis tool is required which discriminates the transmitter signals received by the receiver and detects the reception timing and reception power. For this purpose, a transmitter identification (TxID) technology is proposed which can identify the signals received from the respective transmitters and repeaters at specific reception positions by inserting inherent IDs into the transmitters and repeaters. The transmitter identification signal may be inserted in a parameter type, such as transmitter identification information (TII) used in Eureka 147 or Korean T-DMB, or may be inserted into data symbols in a frequency spread spectrum type, such as TxID standard of ATSC. The transmitter identification signal may be transmitted with a low transmission power while being added to the broadcasting signal. Furthermore, compared with the broadcasting signal, the transmitter identification signal has a very low transmission power and a high processing gain. Thus, The influence on the reception performance of the broadcasting signal receiver is very slight, and the reliability of the transmitter identification is high. Such a transmitter identification (TxID) is not identified in most receivers, but is identified by a special receiver and used for specific purposes, such as a network design and a channel estimation.

The existing broadcasting network provides services not in a limited area but a nationwide or wide local area. Therefore, like a mobile communication network, the broadcasting network supports services by dividing the area into a cell which may be managed by a single base station. Furthermore, if the base station transits data with the increased transmission power in order to widen the cell radius, interference may occur in the adjacent cells. For this reason, the cell radius may be limited. A technology which enables the receiving terminal to receive seamless services between the cells is a handover or handoff technology. Therefore, various standards have been developed for supporting the efficient handover or handoff technology in most networks which support the mobility of the receiving terminal, as well as the broadcasting networks.

Furthermore, in the existing mobile broadcasting standards, the handoff has already been supported, or the standardization is in progress in order to support the handoff. However, when the mobile broadcasting standard is based on the fixed reception broadcasting standard in which the handoff is unnecessary, or the handoff support is not sufficiently considered in the early standard establishment, a lot of technical limitation factors may happen when adding the handoff function. Such technical limitation factors lower the efficiency of the handoff scheme.

As another method for supporting the handoff, two or more tuners are provided inside a single receiver. One of the two or more tuners receives a broadcasting service of a corresponding area, and another tuner scans other broadcasting frequency channel and searches an optimal broadcasting frequency channel receiving the same service. However, this method has a very high complexity of implementation, and the size of the receiver becomes large. Specifically, in the case of a portable mobile receiver operating with a battery power, the life of the battery is reduced. Consequently, there is a need for technology which performs the efficient handoff while utilizing the existing system.

### SUMMARY OF THE INVENTION

An embodiment of the present invention is directed to an apparatus and method for transmitting and receiving signals for handoff, which are compatible with the existing broadcasting standards.

Another embodiment of the present invention is directed to an apparatus and method for transmitting and receiving signals for handoff, which are capable of providing the seamless broadcasting service.

Another embodiment of the present invention is directed to an apparatus and method for transmitting and receiving signals for handoff, which are capable of minimizing the influence on the existing broadcasting service quality.

Another embodiment of the present invention is directed to an apparatus and method for transmitting and receiving signals for handoff, which are capable of reducing the size of the receiving terminal.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for transmitting a signal for handoff in a transmitter of a broadcasting network where a plurality of center frequencies exist includes: a baseband broadcasting signal generation unit configured to generate a baseband broadcasting signal from broadcasting data to be transmitted; a transmitter identification signal sequence generation unit configured to generate a transmitter identification signal of the transmitter; a first transmission unit configured to combine the baseband broadcasting signal and the transmitter identification signal, and up-convert the combined signal to a center frequency of the transmitter; and a second transmission unit configured to modulate the transmitter identification signal, and up-convert the modulated transmitter identification signal to center frequencies of adjacent transmitters.

In accordance with another embodiment of the present invention, an apparatus for transmitting a signal for handoff in a transmitter of a broadcasting network where a plurality of center frequencies exist includes: a baseband broadcasting signal generation unit configured to generate a baseband broadcasting signal from broadcasting data to be transmitted; a transmitter identification signal sequence generation unit configured to generate a transmitter identification signal of the transmitter; a first transmission unit configured to modulate the baseband broadcasting signal, and up-convert the modulated baseband broadcasting signal to a center frequency of the transmitter; and a second transmission unit configured to modulate the transmitter identification signal, and up-convert the modulated transmitter identification signal to center frequencies of adjacent transmitters.

In accordance with another embodiment of the present invention, an apparatus for receiving a signal for handoff in a broadcasting network where a plurality of center frequencies exist includes: a wireless reception unit configured to receive and modulate a broadcasting signal including a preset transmitter identification signal and a signal constituted with only transmitter identification signals of adjacent transmitters over a preset frequency band; a baseband received signal processing unit configured to convert the broadcasting signal including the transmitter identification signal into broadcasting data; a baseband broadcasting signal generation unit configured to convert the broadcasting data into a baseband broadcasting signal; an extraction unit configured to extract the transmitter identification signal by removing the broadcasting signal from the broadcasting signal including the transmitter identification signal; a transmitter identification signal sequence detection unit configured to measure signal qualities of transmitters corresponding to the transmitter identification signals by using the transmitter identification signals; and a channel or frequency selection unit configured to compare the measured signal qualities of the transmitters, determine whether to perform the handoff according to the comparison result, and select an optimal frequency channel.

In accordance with another embodiment of the present invention, an apparatus for receiving a signal for handoff in a broadcasting network where a plurality of center frequencies exist includes: a wireless reception unit configured to receive and modulate a currently received broadcasting signal and a signal constituted with only transmitter identification signals of adjacent transmitters over a preset frequency band; a baseband received signal processing unit configured to convert the received broadcasting signal into broadcasting data; a quality measurement/conversion unit configured to measure a reception quality of the received broadcasting signal by using the broadcasting data, and adjust the measured reception qualities by using a reset ratio; a transmitter identification signal sequence detection unit configured to measure signal qualities of transmitters corresponding to the transmitter identification signals by using the transmitter identification signals; and a channel or frequency selection unit configured to compare the reception quality of the received broadcasting signal and the measured signal qualities of the transmitters, determine whether to perform the handoff according to the comparison result, and select an optimal frequency channel.

In accordance with another embodiment of the present invention, a method for receiving a signal for handoff in a broadcasting network where a plurality of center frequencies exist includes: receiving and modulating a broadcasting signal including a preset transmitter identification signal and a signal constituted with only transmitter identification signals of adjacent transmitters over a preset frequency band; converting the broadcasting signal including the transmitter identification signal into broadcasting data; recovering the broadcasting data into a baseband broadcasting signal; extracting the transmitter identification signal by removing the broadcasting signal from the broadcasting signal including the transmitter identification signal; measuring a reception quality of the preset transmitter by using the transmitter identification signals; measuring reception qualities of the adjacent transmitters; and comparing the measured reception quality of the preset transmitter with a preset threshold value, compare the measured reception quality of the preset transmitter with the reception qualities of the transmitters, and select a channel.

### BRIEF DESCRIPTION OF THE DRAWINGS

FIG. 1 illustrates a broadcasting signal transmission network architecture in accordance with an embodiment of the present invention.

FIG. 2 illustrates a broadcasting signal transmission network architecture in accordance with another embodiment of the present invention.

FIG. 3 is a configuration diagram of a transmitter in the broadcasting network architecture of FIG. 1.

FIG. 4 is a configuration diagram of a transmitter in the broadcasting network architecture of FIG. 2.

FIG. 5 is a configuration diagram of a transmitter which transmits signals received from first to third RF units through respective transmit antennas over a wireless medium, without passing through the mixer included in the first embodiment of FIG. 3.

FIG. 6 is a configuration diagram of a transmitter which transmits signals received from first to third RF units through respective transmit antennas over a wireless medium, without passing through the mixer included in the second embodiment of FIG. 4.

FIG. 7 is a configuration diagram of a receiver corresponding to the transmitters of FIGS. 3 and 5.

FIG. 8 is a configuration diagram of a receiver corresponding to the transmitters of FIGS. 4 and 6.

FIG. 9 is a flowchart illustrating the operation of the broadcasting signal reception unit according to the broadcasting signal transmission network architecture of FIG. 1 and the reception unit structure of FIG. 7.

FIG. 10 is a flowchart illustrating the operation of the broadcasting signal reception unit according to the broadcasting signal transmission network architecture of FIG. 2 and the reception unit structure of FIG. 8.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

In accordance with exemplary embodiments of the present invention, the reception quality of broadcasting signals from the respective broadcasting signal transmitters which are necessary for handoff may be measured simply and efficiently at a physical layer of a broadcasting signal receiver, that is, at a received signal processing step. The handoff is performed by rapidly measuring the variation in the signal reception quality of a corresponding transmitter and its adjacent transmitter according to the movement of the receiver. Furthermore, since the receiving apparatus and method in accordance with the exemplary embodiments of the present invention have the compatibility with the existing broadcasting system, the handoff function may be easily provided by additionally applying them to the existing broadcasting system.

Hereinafter, exemplary embodiments of the present invention will be described in detail with reference to the accompanying drawings.

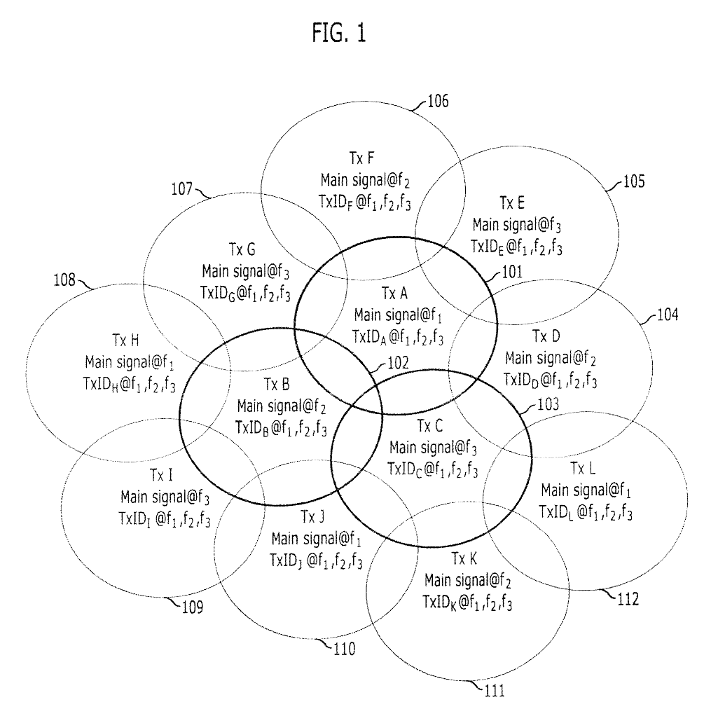

FIG. 1 illustrates a broadcasting signal transmission network architecture in accordance with an embodiment of the present invention.

It is assumed that the transmission network of FIG. 1 includes twelve cells “Tx A” to “Tx L” 101 to 112 and uses three broadcasting frequencies f₁, f₂ and f₃ in order to provide a broadcasting service all over the country. It is assumed that those frequencies are reused, that is, different frequencies are used in adjacent cells, and the same frequencies are used in cells which are not affected by the used frequency. In this way, those frequencies are allocated to the respective broadcasting signal transmitters in order to prevent the waste of frequency resources. In addition, TxID_{A}, TxID_{B}, . . . in FIG. 1 represent transmitter identification signals of a broadcasting signal transmitter A, a broadcasting signal transmitter B, . . . , respectively. The respective broadcasting signal transmitters transmit main broadcasting signals by using frequencies allocated thereto. The transmitter identification signal TxID used to identify the transmitter is transmitted over the broadcasting frequency channel allocated to the main broadcasting signal. The same transmitter identification signals are transmitted with a low transmission power over the other broadcasting frequencies allocated to the transmitters adjacent to the respective broadcasting signal transmitters. In the transmission network of FIG. 1, wherever the receiver operates, it receives the transmitter identification signals from all adjacent broadcasting signal transmitters.

Hereinafter, a case where the receiver operates within the service area of the transmitter A will be described as an example. When the receiver operating within the service area of the transmitter A receives the signal over the broadcasting frequency f₁ allocated to the transmitter A, the received signal includes the broadcasting signal transmitted from the transmitter A and the transmitter identification signal TxID_{A} of the transmitter A. In addition, the receiver may receive some of the transmitter identification signals TxID_{B}, TxID_{C}, TxID_{D}, TxID_{E}, TxID_{F} and TxID_{G} which are transmitted from the transmitters B, C, D, E, F and G adjacent to the transmitter A over the broadcasting frequency f₁.

The receiver receiving the transmitter identification signal from the adjacent transmitter detects the broadcasting signal having the highest reception quality among the transmitter identification signals which are simultaneously received over the same frequency in such a situation that the receiver is moving or the channel state is changing. Also, since the channel is automatically switched to the broadcasting frequency of the corresponding transmitter, the seamless broadcasting service may be received without additional manipulation of the receiver. In this case, during the procedure of detecting the optimal broadcasting signal and automatically switching the channel according to the detection result, a ping-pong effect occurs frequently. That is, the channel switching which frequently crosses the boundary of the channels occurs unnecessarily frequently. To prevent the ping-pong effect, whether the channel is moved may be determined with reference to a hysteresis, that is, a threshold value at which the channel is determined as being completely switched. Furthermore, unnecessary movement of the channels may be prevented using the average value of the reception qualities measured over a certain time. In addition to a method of determining a handoff according to the comparison result of the reception qualities of the transmitter identification signals received at every moment, the handoff may be determined by performing the reception quality comparison of the transmitter identification signals received only when the reception quality of the currently received broadcasting service is lowered below a predetermined threshold value.

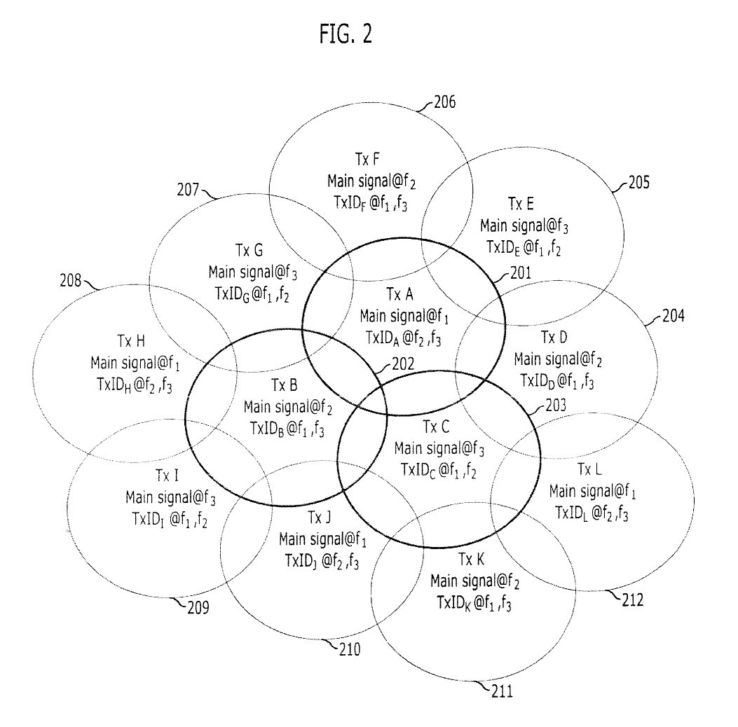

FIG. 2 illustrates a broadcasting signal transmission network architecture in accordance with another embodiment of the present invention.

The transmission network architecture of FIG. 2 is substantially identical to that of FIG. 1. The frequency allocation and the generation of the transmitter identification signals in the transmission network of FIG. 2 are substantially identical to those in the transmission network of FIG. 1. However, unlike in the transmission network of FIG. 1, the transmitter identification signal of the corresponding transmitter is transmitted over the frequency allocated to the corresponding transmitter.

Hereinafter, a case where the receiver operates within the service area of the transmitter A will be described as an example. While the transmitter A transmits its main broadcasting signal over the frequency f₁ allocated thereto, the transmitter identification signal of the transmitter A is not transmitted. While the receiver operating within the service area of the transmitter A receives the broadcasting signal over the broadcasting frequency f₁ allocated to the transmitter A, the receiver does not receive the transmitter identification signal TxID_{A} of the transmitter A, as opposed to the receiver of FIG. 1. This is because the strength of its own signal may be measured from the main broadcasting signal.

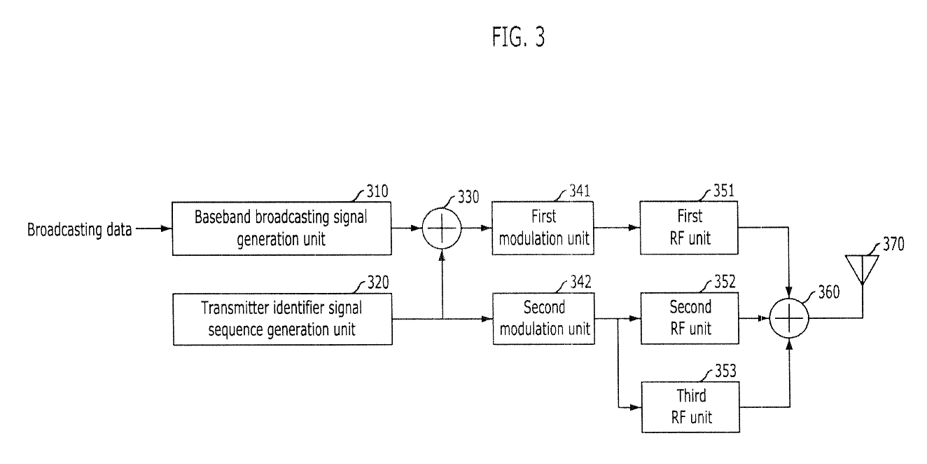

FIGS. 3 to 6 are configuration diagrams of broadcasting signal transmitters according to exemplary embodiments of the present invention. When the broadcasting signal transmitters of FIGS. 3 to 6 are used, four embodiments are possible. The respective embodiments will be described below.

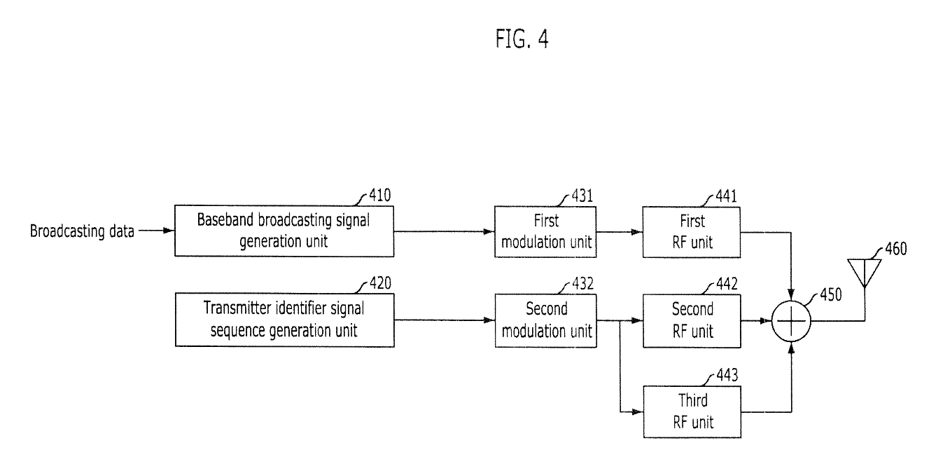

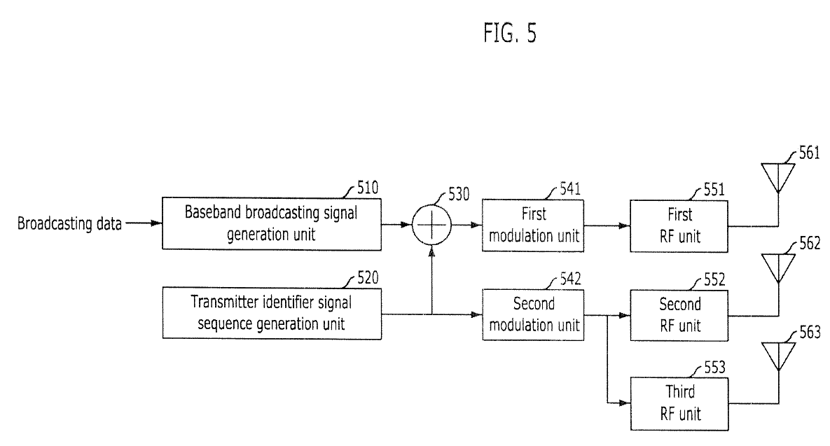

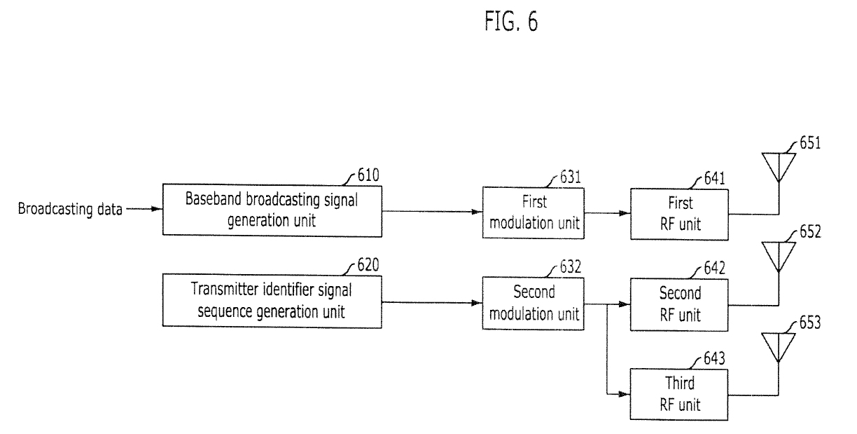

The first embodiment has the architecture of FIG. 1, and the second embodiment has the architecture of FIG. 4. The third embodiment has the architecture of FIG. 5, and the fourth embodiment has the architecture of FIG. 6. Furthermore, the first embodiment and the third embodiment are examples where the broadcasting network architecture of FIG. 2 is applied, and the second embodiment and the fourth embodiment are examples where the broadcasting network architecture of FIG. 2 is applied. The first to fourth embodiments will be described below, based on FIGS. 1 and 2, on the assumption that three frequencies f₁, f₂ and f₃ are used in the broadcasting network architecture. The respective embodiments will be described below in detail.

### First Embodiment of Transmitter

FIG. 3 is a configuration diagram of a transmitter in the broadcasting network architecture of FIG. 1.

The configuration of the transmitter will be described with reference to FIG. 3. Referring to FIG. 3, the transmitter for inserting a transmitter identification code and transmitting a broadcasting signal includes a baseband broadcasting signal generation unit 310, a transmitter identification signal sequence generation unit 320, a combiner 330, a first modulation unit 341, a second modulation 342, a first RF unit 351, a second RF unit 352, a third RF unit 353, a mixer 360, and a transmit antenna 370. The first modulation unit 341 and the first RF unit 351 are referred to as a first transmission unit, and the second modulation unit 342 and the second RF unit 352 are referred to as a second transmission unit.

The baseband broadcasting signal generation unit 310 receives broadcasting data from a broadcasting station, and generates a baseband broadcasting signal to the combiner 330. The transmitter identification signal sequence generation unit 320 generates an identification signal sequence of a corresponding broadcasting signal transmitter to the combiner 330 and the second modulation unit 342. The combiner 330 inserts the transmitter identification signal generated from the transmitter identification signal sequence generation unit 320 into the baseband broadcasting signal outputted from the baseband broadcasting signal generation unit 310, and the resulting signal to the first modulation unit 341. The first modulation unit 341 modulates the signal received from the combiner 330, and transmits the modulated signal to the first RF unit 351. The first RF unit 351 up-converts the broadcasting signal, where the transmitter identification code modulated by the first modulation unit 341 is inserted, to the frequency allocated to the corresponding transmitter, and transmits the up-converted signal to the mixer 360.

The second modulation unit 342 modulates the corresponding transmitter identification code generated by the transmitter identification signal sequence generation unit 320, and transmits the modulated signal to the second RF unit 352 and the third RF unit 353, except the first RF unit 351, in order to transmit the signal over the different frequency used in the broadcasting network architecture, except the frequency allocated to the corresponding transmitter. The second RF unit 352 and the third RF unit 353 up-convert the modulated signal received from the second modulation unit 342 to the other frequencies except the frequency of the corresponding transmitter, and transmits the up-converted signal to the mixer 360. When there are three or more frequencies, as many RF units as the frequencies transmitted from adjacent base stations are required. The number of center frequencies among the adjacent base stations increases according to the number of frequency reuse factors, and the number of the RF units also increases in proportion to the number of the center frequencies.

The mixer 360 mixes the broadcasting signal, where the corresponding transmitter identification code received from the first RF unit 351 is inserted, and the transmitter identification signals, which are received from the second RF unit 352 and the third RF unit 353 and mapped with the frequencies except the frequency allocated to the corresponding transmitter, and transmits the mixed signal to the transmit antenna 370. The transmit antenna 370 transmits the mixed signal received from the mixer 360 over a wireless medium.

The operation of the above-mentioned transmitter will be exemplarily described, focusing on the transmitter A of FIG. 1. The transmitter A uses the frequency f₁, and generates the transmitter identification signal TxID_{A}. The baseband broadcasting signal generation unit 310 receives and converts the broadcasting data into the baseband broadcasting signal, and transmits the baseband broadcasting signal to the combiner 330. The transmitter identification signal generation unit 320 generates the identification signal TxID_{A} of the transmitter A, and transmits the generated identification signal TxID_{A} to the combiner 330 and the second modulation unit 342. The combiner 330 inserts the identification signal TxID_{A} of the transmitter A into the baseband broadcasting signal generated by the baseband broadcasting signal generation unit 310, and transmits the resulting signal to the first modulation unit 341. The first modulation unit 341 transmits the output signal of the combiner 330 to the first RF unit 351. The first RF unit 351 up-converts the output signal of the combiner 330 to the frequency f₁ of the transmitter A, and transmits the up-converted signal to the mixer 360.

The mixer 360 mixes the signals received from the first to third RF units 351 to 353, and transmits the mixed signal to the transmit antenna 370. The transmit antenna 370 transmits the mixed signal over a wireless medium.

### Second Embodiment of Transmitter

FIG. 4 is a configuration diagram of a transmitter in the broadcasting network architecture of FIG. 2.

A difference from the first embodiment of FIG. 3 is that the combiner 330 is excluded. The baseband broadcasting signal generation unit 410 converts broadcasting data into a baseband broadcasting signal, and transmits the baseband broadcasting signal to a first modulation unit 431. The first modulation unit 431 modulates the baseband broadcasting signal, and transmits the modulated baseband broadcasting signal to a first RF unit 441. The first RF unit 441 up-converts the modulated broadcasting signal received from the first modulation unit 431 to the frequency of the corresponding transmitter, and transmits the up-converted signal to a mixer 450.

A transmitter identification signal sequence generation unit 420 generates a corresponding transmitter identification code to a second modulation unit 432. The second modulation unit 432 modulates the transmitter identification code, and transmits the modulated transmitter identification code to the second RF unit 442 and the third RF unit 443. The second RF unit 442 and the third RF unit 443 up-convert the other frequencies except the frequency of the corresponding transmitter, and transmit the up-converted signals to a mixer 450. The mixer 450 mixes the broadcasting signal and the transmitter identification signal received from the first to third RF units 441 to 443, and transmits the mixed signal to a transmit antenna 460. The transmit antenna 460 transmits the mixed signal received from the mixer 450 over a wireless medium. The first modulation unit 431 and the first RF unit 441 are referred to as a first transmission unit, and the second modulation unit 432 and the second RF unit 442 are referred to as a second transmission unit.

The operation of the above-mentioned transmitter will be exemplarily described, focusing on the transmitter A of FIG. 2. The baseband broadcasting signal generation unit 410 of the transmitter A converts the broadcasting data into the baseband broadcasting signal, and transmits the baseband broadcasting signal to the first modulation unit 431. The first modulation unit 431 modulates the baseband broadcasting signal, and transmits the modulated baseband broadcasting signal to the first RF unit 441. The first RF unit 441 up-converts the modulated baseband broadcasting signal to the frequency f₁ of the transmitter A, and transmits the up-converted signal to the mixer 450. The transmitter identification signal generation unit 420 generates the identification signal TxID_{A} of the transmitter A, and transmits the generated identification signal TxID_{A} to the second modulation unit 432. The second modulation unit 432 receives and modulates the identification signal TxID_{A} of the transmitter A, and transmits the modulated identification signal to the second RF unit 442 and the third RF unit 443. The second RF unit 442 and the third RF unit 443 up-converts the identification signal TxID_{A} of the transmitter A, which is modulated with the frequencies f₂ and f₃ except the frequency f₁ of the transmitter A, and transmits the up-converted signal to the mixer 450.

The mixer 450 mixes the signals received from the first to third RF units 441 to 443, and transmits the mixed signal to the transmit antenna 460. The transmit antenna 460 transmits the mixed signal over a wireless medium.

### Third Embodiment of Transmitter

FIG. 5 is a configuration diagram of a transmitter which transmits signals received from first to third RF units through respective transmit antennas over a wireless medium, without passing through the mixer included in the first embodiment of FIG. 3.

A combiner 530 inserts an identification signal of a corresponding transmitter into a broadcasting signal converted into a baseband signal by a baseband broadcasting signal generation unit 510. A first modulation unit 541 modulates the output signal of the combiner 530, and transmits the modulated signal to a first RF unit 551. The first RF unit 551 up-converts the modulated signal received from the first modulation unit 541 to the frequency of the corresponding transmitter, and transmits the up-converted signal through a first transmit antenna 561. A second modulation unit 542 modulates a transmitter identification signal generated by a transmitter identification signal sequence generation unit 520. A second RF unit 552 and a third RF unit 553 map the modulated transmitter identification signal with frequencies except the frequency of the corresponding transmitter, and the mapped signals are transmitted through a second transmit antenna 562 and a third transmit antenna 563. The first modulation unit 541 and the first RF unit 551 are referred to as a first transmission unit, and the second modulation unit 542, the second RF unit 552, and the third RF unit 553 are referred to as a second transmission unit.

### Fourth Embodiment of Transmitter

FIG. 6 is a configuration diagram of a transmitter which transmits signals received from first to third RF units through respective transmit antennas over a wireless medium, without passing through the mixer included in the second embodiment of FIG. 4.

A baseband broadcasting signal generation unit 610 converts a broadcasting signal into a baseband broadcasting signal. A first modulation unit 631 modulates the baseband broadcasting signal, and transmits the modulated baseband broadcasting signal to a first RF unit 641. The first RF unit 641 up-converts the modulated baseband broadcasting signal to the frequency of the corresponding transmitter, and transmits the up-converted signal through a first transmit antenna 651. A transmitter identification signal sequence generation unit 620 generates a transmitter identification signal, and a second modulation unit 632 modulates the transmitter identification signal. A second RF unit 642 and a third RF unit 643 map the modulated signal with frequencies except the frequency of the corresponding transmitter, and the mapped signals are transmitted through a second transmit antenna 652 and a third transmit antenna 653. The first modulation unit 631 and the first RF unit 641 are referred to as a first transmission unit, and the second modulation unit 632, the second RF unit 642, and the third RF unit 643 are referred to as a second transmission unit.

### First Embodiment of Receiver

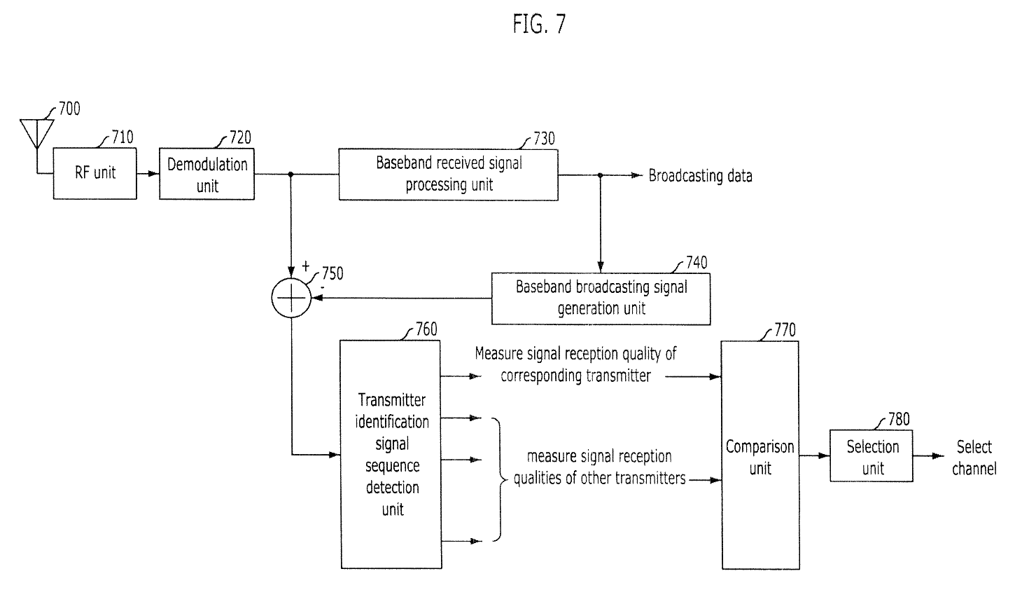

FIG. 7 is a configuration diagram of a receiver corresponding to the first and third embodiments, that is, the transmitters of FIGS. 3 and 5.

Referring to FIG. 7, the receiver includes a receive antenna 700, an RF unit 710, a demodulation unit 720, a baseband received signal processing unit 730, a baseband broadcasting signal generation unit 740, an extraction unit 750, a transmitter identification signal sequence detection unit 760, a comparison unit 770, and a selection unit 780. The RF unit 710 and the demodulation unit 720 are referred to as a wireless reception unit, and the comparison unit 770 and the selection unit 780 are referred to as a channel or frequency selection unit.

The operation of the receivers in accordance with the first and third embodiments will be described below with reference to FIG. 7. The receive antenna 700 transmits the received broadcasting signal to the RF unit 710. The RF unit 710 extracts or filters the signal of the frequency band allocated to the transmitter, and transmits the extracted or filtered signal to the demodulation unit 720. The demodulation unit 720 demodulates the signal received from the RF unit 710, and transmits the demodulated signal to the baseband received signal processing unit 730 and the extraction unit 750. The signal demodulated by the demodulation unit 720 may be a broadcasting signal including a transmitter identification signal, or a transmitter identification signal itself.

The following description will be made on the assumption that the receiver is located in the area of the transmitter A of FIG. 1. Since the RF unit 710 is located in the area of the transmitter A, the RF unit 710 transmits the signal corresponding to the frequency f₁ of the transmitter A to the demodulation unit 720. The demodulation unit 720 demodulates the signal received from the RF unit 710, and transmits the broadcasting signal including the identification signals TxID_{A}, TxID_{B}, TxID_{C}, TxID_{D}, . . . of several transmitters to the baseband received signal processing unit 730 and the extraction unit 750. The baseband received signal processing unit 730 restores the broadcasting signal including the identification signals TxID_{A}, TxID_{B}, TxID_{C}, TxID_{D}, . . . of the transmitters, which are received from the demodulation unit 720, into broadcasting data. In order to extract the transmitter identification signals, the baseband broadcasting signal generation unit 740 converts the broadcasting data generated by the baseband received signal processing unit 730 into the baseband signal, and transmits the baseband signal to the extraction unit 750.

The extraction unit 750 extracts the transmitter identification signals by removing the broadcasting signal, which is received from the baseband broadcasting signal generation unit 740, from the output signal of the demodulation unit 720, that is, the signal in which the transmitter identification signals are included in the broadcasting signal, and transmits the extracted transmitter identification signals to the transmitter identification signal sequence detection unit 760. The transmitter identification signal sequence detection unit 760 measures the signal qualities of the respective transmitters by using the identification signals TxID_{A}, TxID_{B}, TxID_{C}, TxID_{D}, . . . included in the signal received from the extraction unit 750, and transmits the measured signal qualities to the comparison unit 770. The comparison unit 770 compares the respective signal qualities and provides the comparison value to the selection unit 780. The selection unit 780 compares the comparison value received from the comparison unit 770 with a preset threshold value, and selects a channel according to the comparison result.

### Second Embodiment of Receiver

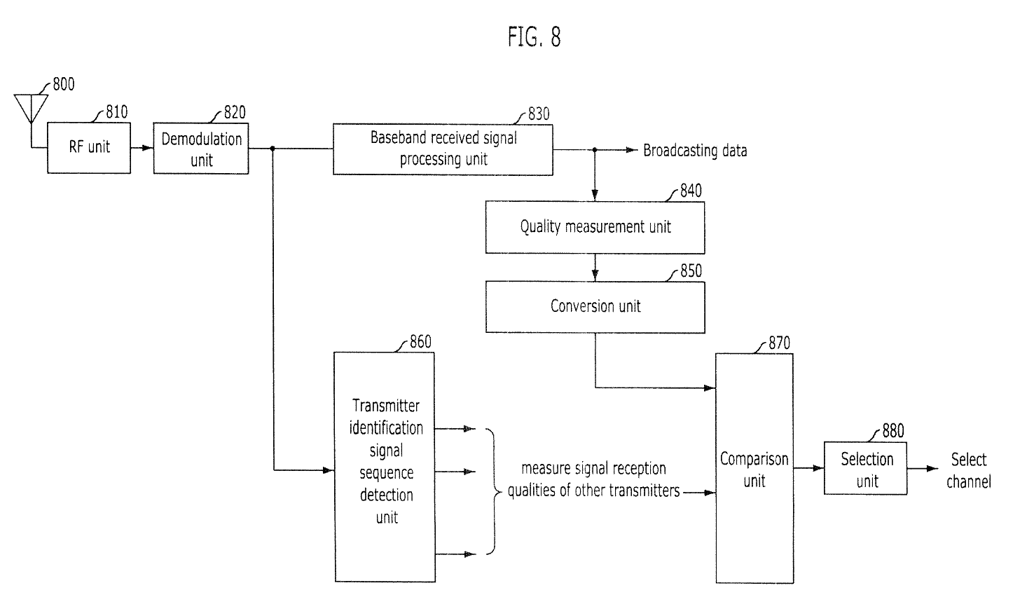

FIG. 8 is a configuration diagram of a receiver corresponding to the second and fourth embodiments, that is, the transmitters of FIGS. 4 and 6.

Referring to FIG. 8, the receiver includes a receive antenna 800, an RF unit 810, a demodulation unit 820, a baseband received signal processing unit 830, a quality measurement unit 840, a conversion unit 850, a transmitter identification signal sequence detection unit 860, a comparison unit 870, and a selection unit 880. The RF unit 810 and the demodulation unit 820 are referred to as a wireless reception unit, and the quality measurement unit 840 and the conversion unit 850 are referred to as a quality measurement/conversion unit. The comparison unit 870 and the selection unit 880 are referred to as a channel or frequency selection unit. The operation of the receiver in accordance with the second embodiment is identical to that of the receiver in accordance with the first embodiment until the procedure of the demodulation unit 820. The demodulation unit 820 demodulates the signal received from the RF unit 810, and transmits the demodulated signal to the baseband received signal processing unit 830 and the transmitter identification signal sequence detection unit 860. The baseband received signal processing unit 830 converts the output signal of the demodulation unit 820 into broadcasting data. The quality measurement unit 840 measures the currently received reception quality of the transmitter by using the reception quality of the broadcasting data received from the baseband received signal processing unit 830, and transmits the measured reception quality to the conversion unit 850. In order to compare the currently received reception quality of the transmitter, which is received from the currently quality measurement unit 840, with the reception qualities of other transmitters, the conversion unit 850 adjusts the currently received reception quality of the transmitter, which is received from the quality measurement unit 840, in proportion to the signal strength upon the signal transmission, and transmits the adjusted reception quality to the comparison unit 870. Since the signal strength of the transmitter identification signal is lowered relative to the signal strength of the broadcasting data upon the signal transmission and then transmitted, the signal magnitude of the broadcasting signal is adjusted in proportion to the signal strength of the broadcasting signal and the transmitter identification signal upon the signal transmission in order for the comparison of the reception qualities.

The transmitter identification signal sequence detection unit 860 detects the transmitter identification signal of the transmitters other than the currently communicating transmitter, and transmits the detected transmitter identification signal to the comparison unit 870. The comparison unit 870 compares the currently received reception quality of the transmitter, which is received from the conversion unit 850, with the reception qualities of other transmitters, which are received from the transmitter identification signal sequence detection unit 860, and transmits the comparison value to the selection unit 880. The selection unit 880 compares the comparison value received from the comparison unit 870 with a preset threshold value, and selects a channel according to the comparison result.

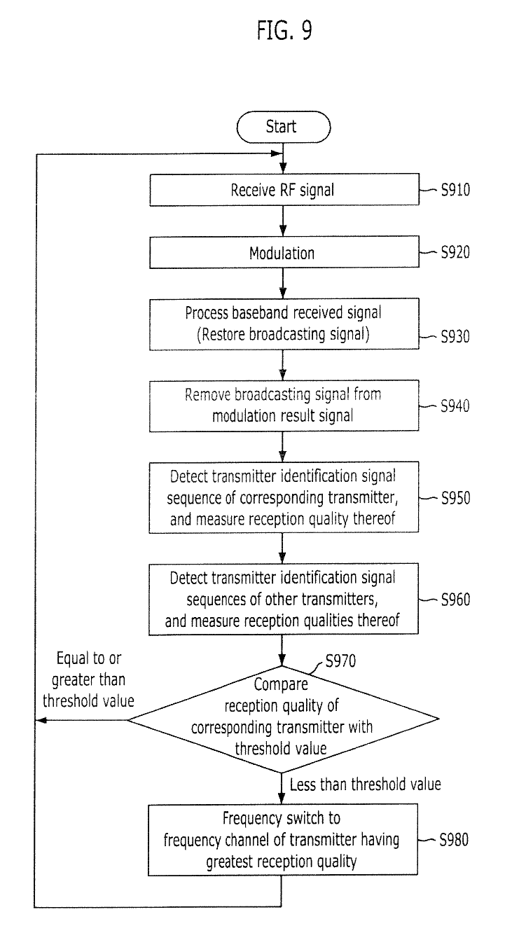

FIG. 9 is a flowchart illustrating the operation of the broadcasting signal reception unit according to the broadcasting signal transmission network architecture of FIG. 1 and the reception unit structure of FIG. 7.

At step S910, the RF unit 710 receives the wireless signal through the antenna, and converts the received wireless signal into the baseband signal. That is, the step S910 is a procedure of receiving the wireless signal. At step S920, the demodulator 720 demodulates the baseband signal received from the RF unit 710. At step S930, the baseband signal processing unit 730 recovers the received broadcasting signal into the broadcasting signal only, and the baseband broadcasting signal generation unit 740 restores the data constituted with only the broadcasting data into the broadcasting signal. At step S940, the extraction unit 750 extracts the signal constituted with only the transmitter identification signal by removing the broadcasting signal, which is restored by the baseband broadcasting signal generation unit 740, from the output signal of the demodulation unit 720, that is, the broadcasting signal in which the transmitter identification signal is included.

At steps S950 and S960, the transmitter identification signal sequence detection unit 760 detects the identification signal sequence of the corresponding transmitter, which is received from the extraction unit 750, and the identification signal sequences of the other transmitters, that is, the currently received identification signal sequences of all transmitters, and measures the signal qualities of the respective transmitters.

At step S970, the comparison unit 770 compares the reception qualities measured in the steps S950 and S960. At step S980, the selection unit 780 determines the handoff based on the comparison value of the step S970. In determining the handoff, when the signal quality of the currently received broadcasting service exceeds a predetermined threshold value, the current broadcasting frequency channel is maintained as it is. On the other hand, when the signal quality of the currently received broadcasting service is lowered below the predetermined threshold value, the broadcasting frequency channel is switched to the broadcasting frequency channel of the transmitter having the greatest value among the measured reception qualities. In the case of the portable terminal operating with a battery power under the mobile reception environment, the power consumption of the receiver may be reduced by reversing the order of the step S960 of detecting other transmitter identification signal sequences and measuring the reception qualities and the step S970 of comparing the reception quality of the corresponding transmitter with the predetermined threshold value.

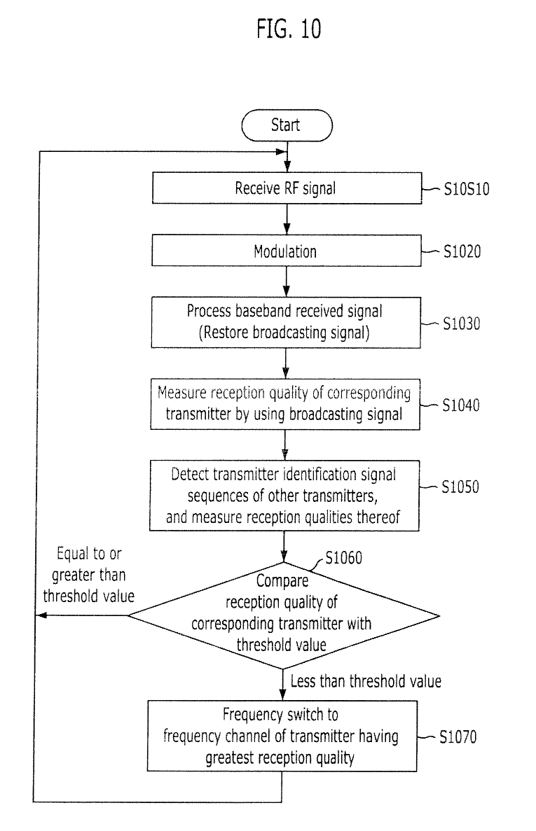

FIG. 10 is a flowchart illustrating the operation of the broadcasting signal reception unit according to the broadcasting signal transmission network architecture of FIG. 2 and the reception unit structure of FIG. 8.

FIG. 10 shows an example according to the broadcasting signal transmission network architecture of FIG. 2. Thus, when the broadcasting signal is transmitted, the identification signal of the corresponding transmitter is not inserted, but the broadcasting signal constituted with only the broadcasting data is generated and transmitted. Therefore, the reception unit of FIG. 8 receives the currently incoming broadcasting signal of the transmitter and the signal constituted with only the transmitter identification signals of other transmitters by using the currently used frequency. Therefore, the baseband received signal processing unit 830, the quality measurement unit 840, and the conversion unit 850 measure the currently received reception quality of the corresponding transmitter by using the broadcasting signal received at step S1040, and transmits the measured reception quality to the comparison unit 870. At step S1050, the transmitter identification signal sequence detection unit 860 detects the identification signal sequences of other transmitters, measures the reception qualities, and transmits the measured reception qualities to the comparison unit 870. Since the subsequent procedures are identical to those of FIG. 9, a further description thereof will be omitted.

In accordance with the exemplary embodiments set forth above, the complexity of implementation is not high, and the broadcasting signal reception unit may effectively measure the information necessary for the handoff by using a single tuner. Furthermore, the influence on the existing broadcasting service is very slight.

In accordance with the exemplary embodiments of the present invention, when the mobile-receivable broadcasting signal receiver moves to an adjacent service zone in the areas where two or more signals having different frequencies exist, such as the nationwide broadcasting or local broadcasting which is difficult to establish a single frequency network (SFN), the automatic handoff to the broadcasting frequency channel for the new service zone is efficiently performed. Therefore, the seamless mobile broadcasting service may be provided, and the compatibility with the existing broadcasting protocols is provided. Consequently, the influence on the existing broadcasting service quality may be minimized.

While the present invention has been described with respect to the specific embodiments, it will be apparent to those skilled in the art that various changes and modifications may be made without departing from the spirit and scope of the invention as defined in the following claims.

What is claimed is:

1. An apparatus for transmitting a signal for handoff in a transmitter of a broadcasting network where a plurality of center frequencies exist, the apparatus comprising:
a baseband broadcasting signal generation unit configured to generate a baseband broadcasting signal from broadcasting data to be transmitted;
a transmitter identification signal sequence generation unit configured to generate a transmitter identification signal of the transmitter;
a first transmission unit configured to combine the baseband broadcasting signal and the transmitter identification signal, and up-convert the combined signal to a center frequency of the transmitter; and
a second transmission unit configured to modulate the transmitter identification signal, and up-convert the modulated transmitter identification signal to center frequencies of adjacent transmitters.

2. The apparatus of claim 1, further comprising a mixer configured to mix an output signal of the first transmission unit and an output signal of the second transmission unit.

3. The apparatus of claim 1, wherein the first transmission unit comprises:
a combiner configured to combine the baseband broadcasting signal and the transmitter identification signal;
a first modulation unit configured to module the combined signal; and
a first RF unit configured to up-convert the modulated signal to the center frequency of the transmitter.

4. The apparatus of claim 1, wherein the second transmission unit comprises:
a second modulation unit configured to modulate the transmitter identification signal; and
second and third RF units configured to up-convert the modulated signal to the center frequencies of the adjacent transmitters.

5. An apparatus for transmitting a signal for handoff in a transmitter of a broadcasting network where a plurality of center frequencies exist, the apparatus comprising:
a baseband broadcasting signal generation unit configured to generate a baseband broadcasting signal from broadcasting data to be transmitted;
a transmitter identification signal sequence generation unit configured to generate a transmitter identification signal of the transmitter;
a first transmission unit configured to modulate the baseband broadcasting signal, and up-convert the modulated baseband broadcasting signal to a center frequency of the transmitter; and
a second transmission unit configured to modulate the transmitter identification signal, and up-convert the modulated transmitter identification signal to center frequencies of adjacent transmitters.

6. The apparatus of claim 5, further comprising a mixer configured to mix an output signal of the first transmission unit and an output signal of the second transmission unit.

7. The apparatus of claim 5, wherein the first transmission unit comprises:
a first modulation unit configured to module the baseband broadcasting signal; and
a first RF unit configured to up-convert the modulated signal to the center frequency of the transmitter.

8. The apparatus of claim 5, wherein the second transmission unit comprises:
a second modulation unit configured to modulate the transmitter identification signal; and
second and third RF units configured to up-convert the modulated signal to the center frequencies of the adjacent transmitters.

9. An apparatus for receiving a signal for handoff in a broadcasting network where a plurality of center frequencies exist, the apparatus comprising:
a wireless reception unit configured to receive and modulate a broadcasting signal including a preset transmitter identification signal and a signal constituted with only transmitter identification signals of adjacent transmitters over a preset frequency band;
a baseband received signal processing unit configured to convert the broadcasting signal including the transmitter identification signal into broadcasting data;
a baseband broadcasting signal generation unit configured to convert the broadcasting data into a baseband broadcasting signal;
an extraction unit configured to extract the transmitter identification signal by removing the broadcasting signal from the broadcasting signal including the transmitter identification signal;
a transmitter identification signal sequence detection unit configured to measure signal qualities of transmitters corresponding to the transmitter identification signals by using the transmitter identification signals; and
a channel or frequency selection unit configured to compare the measured signal qualities of the transmitters, determine whether to perform the handoff according to the comparison result, and select an optimal frequency channel.

10. The apparatus of claim 9, wherein the wireless reception unit comprises:
an RF unit configured to receive the broadcasting signal including the preset transmitter identification signal and the signal constituted with only the transmitter identification signals of the adjacent transmitters over a preset frequency band; and
a demodulation unit configured to demodulate the received signals.

11. The apparatus of claim 9, wherein the channel or frequency selection unit comprises:
a comparator configured to compare the measured signal qualities of the transmitters; and
a selector configured to select a channel or frequency based on the comparison value.

12. An apparatus for receiving a signal for handoff in a broadcasting network where a plurality of center frequencies exist, the apparatus comprising:
a wireless reception unit configured to receive and modulate a currently received broadcasting signal and a signal constituted with only transmitter identification signals of adjacent transmitters over a preset frequency band;
a baseband received signal processing unit configured to convert the received broadcasting signal into broadcasting data;
a quality measurement/conversion unit configured to measure a reception quality of the received broadcasting signal by using the broadcasting data, and adjust the measured reception qualities by using a reset ratio;
a transmitter identification signal sequence detection unit configured to measure signal qualities of transmitters corresponding to the transmitter identification signals by using the transmitter identification signals; and
a channel or frequency selection unit configured to compare the reception quality of the received broadcasting signal and the measured signal qualities of the transmitters, determine whether to perform the handoff according to the comparison result, and select an optimal frequency channel.

13. The apparatus of claim 12, wherein the wireless reception unit comprises:
an RF unit configured to receive the currently received broadcasting signal and the signal constituted with only the transmitter identification signals of the adjacent transmitters over a preset frequency band; and
a demodulation unit configured to demodulate the received signals.

14. The apparatus of claim 12, wherein the quality measurement/conversion unit comprises:
a quality measurement unit configured to measure the reception quality of the received broadcasting signal by using the broadcasting data; and
a conversion unit configured to adjust the measured reception quality by using a preset ratio.

15. The apparatus of claim 12, wherein the channel or frequency selection unit comprises:
a comparator configured to compare the measured signal qualities of the transmitters; and
a selector configured to select a channel or frequency based on the comparison value.

16. A method for receiving a signal for handoff in a broadcasting network where a plurality of center frequencies exist, the method comprising:
receiving and modulating a broadcasting signal including a preset transmitter identification signal and a signal constituted with only transmitter identification signals of adjacent transmitters over a preset frequency band;
converting the broadcasting signal including the transmitter identification signal into broadcasting data;
recovering the broadcasting data into a baseband broadcasting signal;
extracting the transmitter identification signal by removing the broadcasting signal from the broadcasting signal including the transmitter identification signal;
measuring a reception quality of the preset transmitter by using the transmitter identification signals;
measuring reception qualities of the adjacent transmitters; and
comparing the measured reception quality of the preset transmitter with a preset threshold value, compare the measured reception quality of the preset transmitter with the reception qualities of the transmitters, and select a channel.

17. The method of claim 16, wherein, in said comparing the measured reception quality of the preset transmitter with a preset threshold value,
when the reception quality of the preset transmitter is greater than the preset threshold value, a current frequency is maintained, and
when the reception quality of the preset transmitter is less than the present threshold value, a channel of the transmitter having the greatest reception quality among the signal qualities of the adjacent transmitters is selected.

18. The method of claim 16, wherein, in a case of a portable terminal operating with a battery power, said measuring reception qualities of the adjacent transmitters and said comparing the measured reception quality of the preset transmitter with a preset threshold value are reversely performed.
